(19) United States
(12) Patent Application Publication
(10) Pub. No.: US 2026/0005936 A1
(43) Pub. Date: Jan. 1, 2026

(54) CAPTURING AND CATEGORIZING NETWORK TRAFFIC DATA FROM API PAYLOADS FOR COMPREHENSIVE RISK SCANNING

(71) Applicant: OneTrust LLC, Atlanta, GA (US)

(72) Inventors: Josue Negron, Frisco, TX (US); Rakshat Puri, Cincinnati, OH (US)

(21) Appl. No.: 18/756,162

(22) Filed: Jun. 27, 2024

(51) Int. Cl. H04L 43/045; H04L 9/40; H04L 43/026

(52) U.S. Cl. CPC H04L 43/045; H04L 43/026; H04L 63/1416

(57) ABSTRACT

Methods, systems, and non-transitory computer readable storage media are disclosed for capturing, analyzing, and classifying network traffic data associated with a network communication between computing systems. For example, the disclosed systems execute operations to generate classifications of the content of the network traffic data utilizing a classification model. For example, the disclosed systems determine risk levels based on whether network traffic data transmitted within the transport layer of the network traffic data adheres to the requirements of the data policy. In certain aspects, the disclosed systems analyze captured network traffic data based a live network transmissions, logged network transmissions, an API specification, and/or API endpoints. In some aspects, the disclosed systems provide a classification analysis including risk levels associated with the network traffic data via a custom graphical user interface.

### BACKGROUND

Advances in computer processing and data storage technologies have significantly increased the volume and types of data transferred between digital network environments for processing. Specifically, many entities utilize computing devices and/or software applications to store, analyze, and/or perform a number of computing operations based on transferring different types of data. Computing systems involved in handling (e.g., collecting, receiving, transmitting, storing, processing, sharing, and/or the like) certain types of network traffic data are often subject to various internal or external data requirements, such as security, privacy, legal, or ethical requirements. Accordingly, to fulfill the requirements for handling the network traffic data, entities that handle network traffic data often execute various operations on network traffic data. In managing network traffic data for websites, entities often utilize application programming interfaces (“APIs”) that interact with frontend user interfaces and transmit backend data not directly visible to users.

Many entities generate a significant volume of metadata, payloads, data elements, data feature and other network data when interacting over digital networks. Some conventional data management systems automatically process these large volumes of data for various reasons, including cookie compliance, consent management, and application interactions. This significant volume of networking data often creates a disconnect between the user interface (“UI”) requirements for frontend applications and data generated/passed during API interactions. This disparity can result in inaccurate data handling and the unnecessary exposure of sensitive information (e.g., personally identifiable information (“PII”)) within the data transport layer. For example, in conventional data management systems, APIs are frequently reused for multiple purposes without adequate consideration for accuracy and data minimization, which results in the transmission of excess PII data through network requests. To illustrate, a backend API might transmit excess data, exposing user email addresses and phone numbers even when only usernames are required for the frontend UI display, thereby introducing discrepancies between the data being processed and displayed.

Because conventional data management systems typically process network data in such a manner, conventional data management systems often fail to ensure compliance with data security (or other) requirements. In some cases, these data management systems include software tools that fail to provide insight into the transactional data flowing across the data transport layer that would indicate that excess data is being transmitted. This deficiency impacts how other computing systems—which are managed using those software tools—are configured for the collection, usage, and purposes of personal data. As an example, those computing systems may collect, without consent, PII via cookies (or other applications), such as saved passwords, which can be used to identify individuals. And while cybersecurity tools use scanners to identify and mitigate risks in network traffic (e.g., tracking vulnerabilities and preventing unauthorized access), the data analyzed with these tools is typically focused on external threats. The data related to the security of APIs is often not verified against data policies, leaving potential risks within the data itself undetected.

### SUMMARY

This disclosure describes various aspects for analyzing and classifying network traffic data associated with a network communication between computing systems for network reporting and risk remediation. For example, the disclosed systems execute operations to generate classifications of the content of captured network traffic data utilizing a classification model. In some aspects, the disclosed systems utilize the classification model to apply classification requirements associated with a data policy to the network traffic data in a transport layer of a computing system. In addition, the disclosed systems determine risk levels based on whether network traffic data transmitted within the request payloads and/or response payloads of application programming interface (API) calls adheres to the requirements of the data policy. In certain aspects, the disclosed systems analyze the captured network traffic data based a series of network interactions, an API specification, and/or API endpoints. In some aspects, the disclosed systems provide the classification analysis, including risk levels associated with the network traffic data, via a custom graphical user interface with tools for remediating risks indicated in the classification analysis.

### BRIEF DESCRIPTION OF THE DRAWINGS

Various aspects will be described and explained with additional specificity and detail through the use of the accompanying drawings.

FIG. 1 illustrates an example of a system environment in which a network data analysis system can operate in accordance with some aspects.

FIG. 2 illustrates an example of an overview of the network data analysis system generating a classification analysis for network traffic data in accordance with some aspects.

FIG. 3 illustrates an example of a sequence of computing system operations in connection with the network data analysis system generating a classification analysis for network traffic data for display on a client device in accordance with some aspects.

FIG. 4 illustrates an example of the network data analysis system determining risk levels for network traffic data extracted from a log file in accordance with some aspects.

FIG. 5 illustrates an example of the network data analysis system utilizing a classification model to classify network traffic data in accordance with some aspects.

FIG. 6 illustrates an example of the network data analysis system determining and utilizing risk levels of network traffic data for risk remediation in accordance with some aspects.

FIG. 7 illustrates an example of a system architecture of the network data analysis system 102 executing a classification analysis of network traffic data in accordance with some aspects.

FIG. 8 illustrates an example of a graphical user interface for requesting a classification analysis for network traffic data in accordance with some aspects.

FIG. 9 illustrates an example of a graphical user interface displaying results of a classification analysis for network traffic data in accordance with some aspects.

FIG. 10 illustrates an example of a graphical user interface displaying results of a classification analysis for network traffic data using visualization tools in accordance with some aspects.

FIG. 11 illustrates an example flowchart of a method for generating a classification analysis of risk levels associated with network traffic data of a computing system in accordance with some aspects.

FIG. 12 illustrates an example of a computing device in accordance with some aspects.

### DETAILED DESCRIPTION

This disclosure describes some aspects of a network data analysis system that classifies network traffic data to assess risk levels associated with network communication between computing systems. For example, the network data analysis system captures network traffic data sent and received by a computing system and executes operations to generate classifications of the content of the network traffic data via a classification model. In some aspects, the network data analysis system utilizes the classification model to apply classification requirements associated with data policies to the network traffic data at a transport layer of the computing system. For example, the network data analysis system determines risk levels based on whether network data transmitted within the request payloads or response payloads of application programming interface (API) calls adheres to the data policy. In some aspects, the network data analysis system also provides an analysis of risk levels associated with the network traffic data via a custom graphical user interface.

The network data analysis system can analyze network traffic data captured for a computing system by extracting data elements from network traffic data between computing systems. In some aspects, the network data analysis system analyzes the network traffic data by scanning network traffic generated using information from a provided API specification and/or API endpoints. The network data analysis system can extract data elements from the content of API calls including content of API request payloads and API response payloads. For example, the network data analysis system can capture network traffic data in the form of packets, extract the content from the network traffic data, and parse the content to extract the data elements. In certain aspects, the network data analysis system analyzes the network traffic data based on a series of recorded network interactions (e.g., in a user journey recorded in a HAR file).

In some aspects, the network data analysis system utilizes a classification neural network to classify the network traffic data according to data types. For example, the network data analysis system utilizes a data policy to provide a dataset of data types (e.g., email, name, address, health record) for the classification of network traffic data. The network data analysis system can determine data types within network traffic data through labeled examples of the different data types. Furthermore, during classification, the classification neural network analyzes the patterns and context within the data to determine the existing data types. In some aspects, the classification neural network classifies each data element within the API request/response payload, assigning the data elements to specific data types of the data policy.

In some aspects, the network data analysis system utilizes the classification of the data types to determine risk levels for the data types within the network traffic data. The network data analysis system can evaluate the sensitivity and potential impact of each data type within the context of the network traffic data. The network data analysis system can also leverage the data policy to determine the risk level for the data types. For example, the network data analysis system assesses each data type for an inherent risk. This can involve analyzing factors such as the probability of a risk occurrence, an impact severity of the risk occurrence, the potential for misuse, likelihood of unauthorized access, the severity of consequences in case of a data breach, and/or the urgency of risk remediation. In addition, the network data analysis system can quantify the risk levels based on the data policy, use context, vulnerability assessments, and/or historical data.

In some aspects, the network data analysis system instigates actions after classifying the network traffic data. In one example, the network data analysis system generates a classification analysis comprising the classifications of the content of the network traffic data and one or more indications of risk levels of the data types in the network traffic data. For instance, the network data analysis system generates a log of the network traffic data which includes the data types, risk levels, and mitigation recommendations. Additionally, or alternatively, the network data analysis system can instigate actions such as generating real-time alerts, increasing the level of monitoring, updating a graphical user interface, initiating advisory emails, and/or logging high-risk data.

Furthermore, in some aspects, the network data analysis system integrates with a client device. For instance, the network data analysis system performs the classification analysis of the network traffic data based on configuration values provided through a graphical user interface on the client device. In addition, the network data analysis system can provide the classification analysis for display on the graphical user interface of the client device. In some aspects, the network data analysis system provides content to display the classification analysis and/or implement graphic elements to represent the classification analysis (e.g., risk levels) for the network traffic data.

Certain aspects of the network data analysis system improve upon shortcomings of conventional data management systems in relation to analyzing and classifying network traffic data. Specifically, conventional data management systems lack efficiency and flexibility in categorizing network traffic data. For example, many computing systems handle large volumes of data automatically, implementing tasks such as interfacing with website visitors, consent management, and cookie compliance. However, in conventional data management systems, backend developers often create and deliver API endpoints that frontend developers use to meet UI requirements or other downstream users (e.g., non-developer users) or operations use to execute additional processes, leading to the unintended transmission of excess data, such as additional or unnecessary information. In addition, conventional data management systems often reuse APIs for multiple purposes without implementing data minimization practices. This reuse of APIs can lead to the transmission of excessive and potentially sensitive data, such as PII, which may not be functionally necessary. These conventional approaches can cause improper data handling and the unnecessary exposure of personally identifiable information (PII) within the data transport layer.

In terms of accuracy, the automated nature of some conventional data management systems often results in network data being transmitted without proper validation or verification, leading to inaccuracies. For instance, without comprehensively interpreting the underlying content of the network traffic data, the superficial categorization of only the data viewed within a graphical user interface can be inaccurate in relation to requirements of specific data policies, resulting in incorrect auditing and reporting. In addition, the superficial categorization of only the data viewed within a graphical user interface or stored within cookies can lead to inaccuracies and heightens the risk of non-compliance with data protection requirements, such as requirements that website operators know precisely what personal data they collect, how it is used, and to obtain explicit user consent.

Regarding flexibility, conventional data management systems often struggle to adapt to changing requirements due to their rigid structure. For example, while some conventional data management systems identify and mitigate potential external security risks to computing systems, such as tracking vulnerabilities and preventing unauthorized access, they primarily focus on external threats. As a result, with conventional data management systems, the network traffic data generated by internal APIs often does not receive sufficient scrutiny, limiting flexibility of conventional data management systems to adapt and satisfy data policy requirements. The failure of internal oversight limits the ability of conventional data management systems ability to adapt quickly to errors regarding compliance with a data policy or changes in the data handling requirements.

In some aspects, the disclosed network data analysis system provides a number of advantages over conventional data management systems. For example, the network data analysis system addresses several problems arising in the realm of network communications of computing systems. In contrast to conventional data management systems that focus on data stored (e.g., in cookies) and/or presented, the network data analysis system accurately detects and classifies data being transmitted by generating a comprehensive categorization of the content of network traffic data sent and received by a computing system. By analyzing and classifying the content of the network traffic data within the data transport layer, the network data analysis system can enhance data minimization practices of a computing system (e.g., by ensuring the computing systems request and provide only data necessary for performing specific operations). For example, the network data analysis system can evaluate the data generated by API calls to determine risk levels associated with data types within the contents of the network traffic data and recommend remediation actions based on the risk levels and an associated data policy (e.g., reduce the exposure of sensitive information such as PII by modifying API calls or computing operations related to the API calls). By detecting issues based on network traffic data classifications and providing remediation actions, the network data analysis system can improve the accuracy of compliance with various policies for a computing system (e.g., CDPR, CCPA, company standards) in data transmitted and received.

Furthermore, the network data analysis system can provide a flexible method for classifying risks associated with network traffic data sent and received by a computing system in connection with remediating the risks. For example, the network data analysis system provides or facilitates classification of the content of the network traffic data based on various sources, such as an API specification, API endpoints, logs of recorded network interactions, and/or real-time network traffic scans. The network data analysis system can also evaluate network traffic data utilizing one or more data policies to determine the sensitivity of the network traffic data, a compliance of the network traffic data with data requirements, and/or a potential impact of risks associated with the network traffic data. The network data analysis system can thus provide users at various levels of operations of a computing system with insight into the data being transmitted to or from the computing system from one or more additional computing systems or devices, even if not all such data is visible in user interfaces and/or cookies.

Additionally, the network data analysis system can improve data security by comprehensively classifying the network traffic data for a computing system. In contrast to conventional data management systems that can leave sensitive data exposed to data breaches or other security/privacy risks through evaluation of limited sets of stored data, the network data analysis system provides a comprehensive evaluation of network traffic data at a data transport layer of a computing architecture. In addition, the network data analysis system can automate a risk notification to provide a timely report of risk level(s) for the content of the network traffic data. Moreover, unlike conventional data management systems that focus on external threats, the network data analysis system provides a classification analysis that includes the risk levels for internally and externally generated network traffic data.

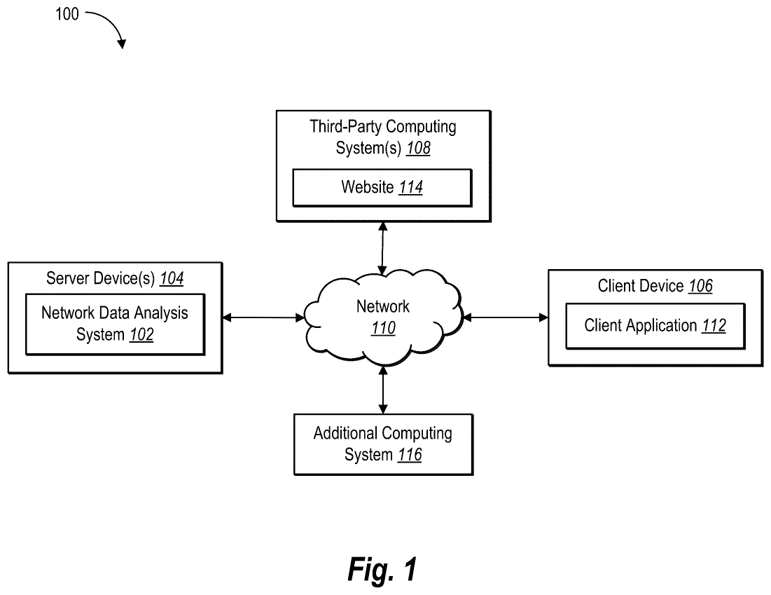

Turning now to the figures, FIG. 1 includes an aspect of a system environment 100 in which a network data analysis system 102 is implemented. In particular, the system environment 100 includes a server system 104, a client device 106, third-party computing system(s) 108, and an additional computing system 116 in communication via a network 110. Moreover, the third-party computing system(s) 108 includes or hosts a website 114. FIG. 1 also shows that the client device 106 includes client application 112.

As shown in FIG. 1, in some aspects, the server system 104 can include or host the network data analysis system 102. Specifically, the network data analysis system 102 includes, or is part of, one or more systems that extract, classify and/or otherwise process network traffic data (e.g., extracting payload data from a transport layer of one or more computing devices) associated with the third-party computing system(s) 108. For example, the network data analysis system 102 analyzes data transmitted over the network generated or received by the third-party computing system(s) 108 and the website 114. In some aspects, the network data analysis system 102 provides tools to the client device 106 via the client application 112 for viewing and managing information associated with the third-party computing system(s) 108 and/or the network traffic data that the entity transmits. For example, the network data analysis system 102 performs operations associated with the network traffic data (e.g., extracts, classifies, processes, transmits, or stores) and provides information to the client device 106 through the client application 112.

As used herein, the term “data type” refers to a categorization for a unit of data that represents a piece of digital information. In particular, a data type can correspond to a data element and represent a value, feature, and/or characteristic of data. For example, a data type can be denoted by a data element such as a number, string of text, date, Boolean value (e.g., true or false determination), decimal and/or combination of the aforementioned features. For instance, data types include indications of PII data such as social security numbers (SSNs), first names, last names, IP addresses, ages, email addresses, telephone numbers, and dates of birth. Data types can also include indications of non-PII data, such as application data, device data, or other data. Additionally, an entity can define the meaning, features, and/or characteristics of the data type and utilize the network data analysis system 102 to collect and/or generate certain information that solely pertains to that entity.

As used herein, the term “network traffic data” refers to units of data (e.g., data packets) that are transmitted across a network. In particular, network traffic data can include one or more data elements exchanged over the network, such as requests, responses, and transactional data. In some aspects, network traffic data includes packets that carry request/response payload information necessary for communication between networked devices. The network traffic data can include headers containing metadata (such as source and destination IP addresses, protocol information, and routing details) and the data being transmitted (such as a web page request, email content, or file transfer data). The network data analysis system 102 can monitor and analyze the network traffic data as described herein to categorize data elements as data types for detecting security threats and/or ensure compliance with data policies. Relatedly, the network traffic data can comprise heterogenous data types (e.g., a mixture of data types with various formats).

In some aspects, the network data analysis system 102 extracts and/or manages data types and network traffic data by communicating with the third-party computing system(s) 108 and the website 114. Specifically, the network data analysis system 102 can communicate with the third-party computing system(s) 108 to determine or otherwise obtain information associated with transmission of the network traffic data.

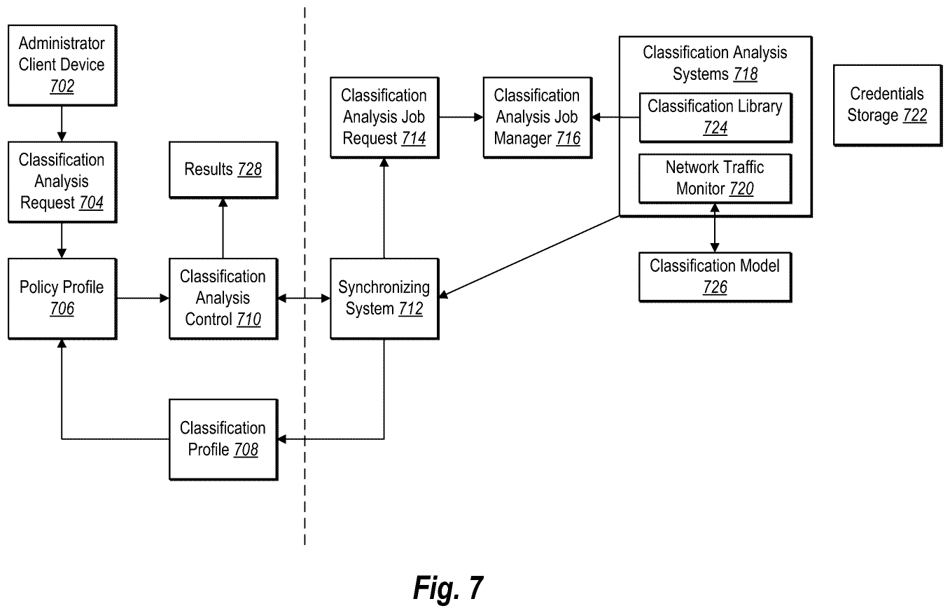

In some aspects, the client device 106 communicates directly with the third-party computing system(s) 108. The network data analysis system 102 may be configured to communicate with the third-party computing system(s) 108 via an integration that is installed on the third-party computing system(s) 108 that is configured with credentials (e.g., via an integrated data extraction software application). The network data analysis system 102 can obtain metadata, data elements, and/or other information about the network traffic data. For example, as further described in relation to FIG. 7, the network data analysis system 102 can include one or more portions in a cloud-based environment and one or more portions in a client-side environment (e.g., at the client device 106 or the third-party computing system(s) 108) to access the third-party computing system(s) 108.

The network data analysis system 102 can further communicate with the additional computing system 116 to manage processing of network traffic data and data elements from the third-party computing system(s) 108. The network data analysis system 102 can capture network data traffic for network interactions between the third-party computing system(s) 108 and the additional computing system 116. For instance, the network data analysis system 102 can determine risk levels of the data types in the network traffic data (e.g., by classifying the data elements and/or network traffic data utilizing a classification neural network) transferred between the third-party computing system(s) 108 and the additional computing system 116.

Furthermore, the network data analysis system 102 can communicate with the client device 106 to obtain information associated with the network traffic data or to provide information about the data types, risk levels, and/or network traffic data for display within the client application 112. For instance, the network data analysis system 102 can obtain, via user input received from the client device 106, API configuration, API payloads, log files, and/or other information about the network traffic data. Furthermore, the network data analysis system 102 can provide for display information regarding the classification and risk levels of the network traffic data to the client device 106 via the client application 112.

In some aspects, the third-party computing system(s) 108 includes server devices, individual client devices, or other computing devices associated with an entity. For instance, a third-party computing system(s) 108 includes one or more network traffic data source(s) and/or one or more computing devices for performing one or more data processes involving handling data associated with one or more operations of the entity subject to various data requirements (e.g., security requirements such as encryption requirements or privacy, legal, or ethical requirements). To illustrate, the third-party computing system(s) 108 includes one or more server devices that generate, process, store, and/or transmit labeled payment card processing data subject to PCI DSS in one or more jurisdictions.

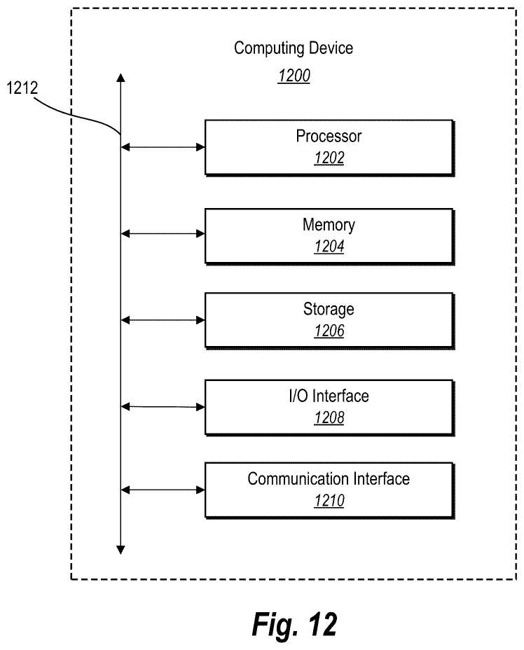

In some aspects, the server system 104 includes a variety of computing devices, including those described below with reference to FIG. 12. For example, the server system 104 includes one or more server devices for storing and processing data associated with one or more data processes. In some aspects, the server system 104 can also include a plurality of computing devices in communication with each other, such as in a distributed storage environment. In some aspects, the server system 104 includes a content server. The server system 104 also optionally includes an application server, a communication server, a web-hosting server, a social networking server, a digital content campaign server, or a digital communication management server.

In some aspects, the client device 106 includes, but is not limited to, a desktop, a mobile device (e.g., smartphone or tablet), or a laptop including those explained below with reference to FIG. 12. Furthermore, although not shown in FIG. 1, the client device 106 can be operated by users (e.g., a user included in, or associated with, the system environment 100) to perform a variety of functions. In particular, the client device 106 performs functions such as, but not limited to, accessing, viewing, and interacting with data elements, network traffic data, classifications, risk levels, data elements, and/or data processes involving the network traffic data in connection with one or more network traffic data requirements or downstream operations. In some aspects, the client device 106 also perform functions for generating, capturing, or accessing data to provide to the network data analysis system 102 in connection with classifying data elements and/or processing the network traffic data. For example, the client device 106 communicates with the server system 104 via the network 110 to provide information (e.g., user interactions) associated with network traffic data, classifications, and/or risk levels. Although FIG. 1 illustrates the system environment 100 with a single client device, in some aspects, the system environment 100 includes a plurality of client devices. In some aspects, the client device 106 or the server system 104 also host the third-party computing system(s) 108.

Additionally, as shown in FIG. 1, the system environment 100 includes the network 110. The network 110 enables communication between components of the system environment 100. In some aspects, the network 110 may include the Internet or World Wide Web. Additionally, the network 110 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server system 104, the client device 106, the third-party computing system(s) 108, the third-party computing system(s) 108, and the additional computing system 116 communicate via the network 110 using one or more communication platforms and technologies suitable for transporting data and/or communication signals, including any known communication technologies, devices, media, and protocols supportive of data communications, examples of which are described with reference to FIG. 12.

Although FIG. 1 illustrates the server system 104, the client device 106, the third-party computing system(s) 108, and the additional computing system 116 communicating via the network 110, in alternative aspects, the various components of the system environment 100 communicate and/or interact via other methods (e.g., the server system 104, the client device 106, the third-party computing system(s) 108, and/or the additional computing system 116 can communicate directly). Furthermore, although FIG. 1 illustrates the network data analysis system 102 and the client device 106 being implemented separately within the system environment 100, the network data analysis system 102 and the client device 106 can alternatively be implemented, in whole or in part, by a particular component and/or device within the system environment 100 (e.g., the server system 104). Additionally, in some aspects, the third-party computing system(s) 108 includes the client device 106.

In some aspects, the network data analysis system 102 can be executed on a server system that provides a multi-tenant environment. The multi-tenant environment can include a tenant (e.g., one or more user accounts sharing common privileges with respect to an application instance) accessible by a particular set of client devices, as well as other tenants inaccessible to that set of client devices (e.g., access controlled to permit only access from other sets of client devices). For instance, in (or otherwise in connection with) the tenant accessible by a particular client system of one or more client devices, certain network traffic data used by the network data analysis system 102 apply to that client system (e.g., the network traffic data correspond to functions or infrastructure of the entity using the client system), with other tenants having other network traffic data, and instances of the software components of the network data analysis system 102 described herein may only be available to the client system, with other tenants having access other instances of these software components. In additional or alternative aspects, the network data analysis system 102 can be implemented on one or more computing systems operated by a single entity. For instance, the network data analysis system 102 (or portions of the network data analysis system 102) can be operated on a first server system controlled by the entity (e.g., via an on-premises installation of software components described herein) and can communicate with a second server system that is a client system controlled by the entity.

In some aspects, the server system 104 supports the network data analysis system 102 on the client device 106. For instance, the server system 104 generates/maintains the network data analysis system 102 and/or one or more components of the network data analysis system 102 for the client device 106. The server system 104 provides the network data analysis system 102 to the client device 106 (e.g., as a software application/suite). In other words, the client device 106 obtains (e.g., downloads) the network data analysis system 102 from the server system 104. At this point, the client device 106 is able to utilize the network data analysis system 102 to classify data elements, manage digital content items, and/or process network traffic data independently from the server system 104.

In alternative aspects, the network data analysis system 102 includes a web hosting application that allows the client device 106 to interact with content and services hosted on the server system 104. To illustrate, in some aspects, the client device 106 access a web page supported by the server system 104. The client device 106 provide input to the server system 104 to perform data classification operations, and, in response, the network data analysis system 102 on the server system 104 performs operations to classify data associated with network traffic data processing. The server system 104 provides the output or results of the operations to the client device 106.

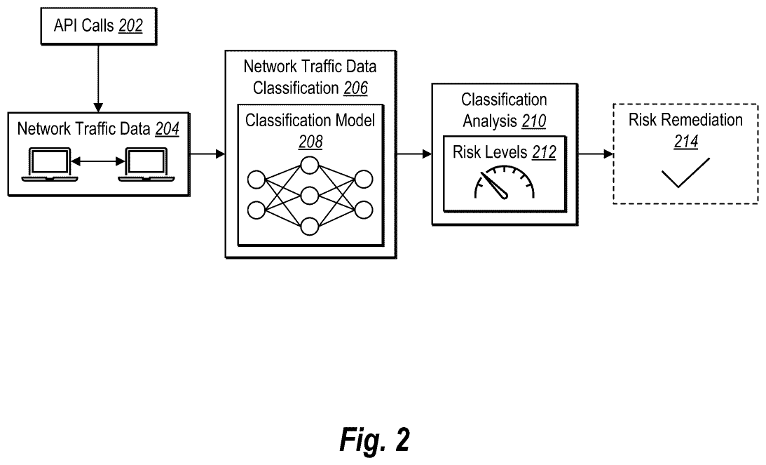

As mentioned, the network data analysis system 102 can perform a classification analysis to determine risk levels associated with data types within the network traffic data. FIG. 2 illustrates an example of an overview of the network data analysis system 102 generating a classification analysis in accordance with some aspects.

As illustrated in FIG. 2, the network data analysis system 102 captures network traffic data 204. In some aspects, the network data analysis system 102 captures the network traffic data 204 from the network traffic between two or more computing systems. For example, the network data analysis system 102 can capture (e.g., scan) the network traffic data 204 comprising request payloads and/or response payloads of API calls 202. To illustrate, the network data analysis system 102 captures network traffic data comprising a series of data packets containing a request payload (e.g., HTTP GET or POST request, SQL query, application request) and associated metadata. Furthermore, the network data analysis system 102 can capture the response payload (e.g., requested data, SQL query results, application response) and associated metadata.

In some aspects, the network data analysis system 102 extracts content from the network traffic data 204 by utilizing a machine-learning model that extracts features and/or metadata related to data elements from the network traffic data. For example, the network data analysis system 102 can extract a data type and data value associated with the data element. To illustrate, in request/response payloads that contain fields for names, addresses, SSNs, checking account balances, etc., the network data analysis system 102 can extract the data elements corresponding to the information in the fields for names, addresses, SSNs, checking account balances, etc. The network data analysis system 102 can also extract additional data elements related to identifying the computing systems/applications involved in the network traffic and/or other data associated with the communications.

In some aspects, the network data analysis system 102 classifies the network traffic data 204 through a network traffic data classification 206. In particular, the network data analysis system 102 classifies the network traffic data 204 by inputting the data elements extracted from the API calls 202 into a classification model 208. As used herein, the term “classification model” refers to one or more computer functions that classify network traffic data into various data types. For example, a classification model 208 processes data elements from the network traffic data and outputs a classification for each data element according to a classification scheme of a data policy.

In some aspects, the classifier model includes a classification machine-learning model or classification neural network that learns to classify data into a set of categories based on features, characteristics, or other attributes of the data element. In some aspects, the classifier model can classify data by utilizing one or more classifiers that match data elements to data types. For example, the classifier model includes a set of computer functions that utilize mappings from a data policy to determine a data type for each data element. In some aspects, the classifier model accesses a classification profile that provides mappings between specific data elements and specific data types based on the attributes and/or features of the data elements.

As used herein, the term “neural network” refers to a computer representation that is tuned (e.g., trained) based on inputs to approximate unknown functions. For instance, a neural network includes one or more layers or artificial neurons that approximate unknown functions by analyzing known data at different levels of abstraction. For example, the classification model 208 includes one or more classification neural network layers (e.g., individual classifiers) trained to identify specific data types.

As further shown in FIG. 2, the network data analysis system 102 generates a classification analysis 210 to determine risk levels associated with the network traffic data. More specifically, the network data analysis system 102 generates risk levels 212 for the network traffic data 204 based on the network traffic data classification 206. As used herein, the term “risk level” refers to a label (e.g., tag, identifier, designation, etc.) reflecting a category or class to which data types within the network traffic data belong in relation to certain risk categories. In some aspects, a risk level corresponds to potential security threats and vulnerabilities associated with the transmission of the data type.

As mentioned, the network data analysis system 102 determines risk levels 212 corresponding to the data types within the network traffic data 204. In some aspects, a risk level can correspond to a classification of a data type. For example, the network data analysis system 102 can determine low risk levels associated with data elements classified as a data type associated with public information. Furthermore, the network data analysis system 102 can determine medium risk levels associated with data elements classified as a data type associated with data elements such as email that require moderate security measures. Moreover, the network data analysis system 102 can determine high risk levels associated with data elements classified as a data type associated with data elements such as PII and intellectual property that require stringent security controls. In some aspects, the risk levels 212 correspond to an assessment of the data type, such as the sensitivity of the data, compliance with regulatory/policy requirements, the likelihood of threats, and the potential impact of a data breach.

As further shown in FIG. 2, the network data analysis system 102 can perform a risk remediation 214. For instance, the network data analysis system 102 can recommend remediation actions based on the risk levels 212 and an associated data policy. To illustrate, the network data analysis system 102 can perform the risk remediation 214 to reduce the exposure of sensitive information such as PII.

For example, the network data analysis system 102 can provide a remediation recommendation to comply with a transport layer encryption standard for SSNs transmitted over the network to prevent the unauthorized interception of PII during transmission. In some aspects, the network data analysis system 102 can generate an automated message based on data types detected within the network traffic data 204. For example, if the classification analysis 210 determines that a risk level exceeds a specified level, the network data analysis system 102 can generate an automated message for a client device that includes indications of a risk level, a data type, a data element, and payload request/response. In certain aspects, the network data analysis system 102 can recommend (or execute) the blocking of certain technologies or modification of API calls based on the risk level exceeding a specified level.

As mentioned, by classifying and determining risk levels associated with network traffic data, the network data analysis system 102 can provide tools to comply with network traffic data requirements of a data policy. For example, the network data analysis system 102 can provide a client device with key information for managing one or more computing devices in connection with network traffic data requirements associated with various legal, ethical, or other standards. To illustrate, network traffic data requirements can include internal or external requirements for handling specific types of data. For instance, network traffic data requirements can include requirements to implement specific controls for handling one or more data types, such as data encryption controls, user access controls, and the like. Furthermore, because certain types of data can have higher sensitivity than other data types, by classifying data elements in the transport layer of the network traffic data and providing risk levels, the network data analysis system 102 provides the means for entities to meet network traffic data requirements of a data policy.

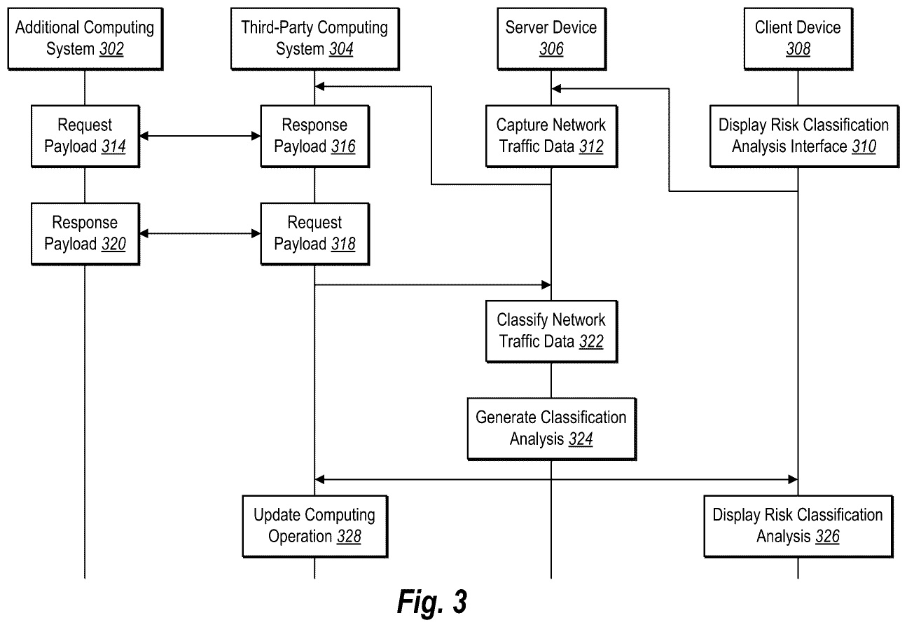

Turning to FIG. 3, FIG. 3 illustrates an example of the network data analysis system 102 generating a classification analysis for display on a client device in accordance with some aspects. As indicated above, the network data analysis system 102 can interact with a client device 308 (e.g., client device 106) to classify network traffic data between a third-party computing system 304 (e.g., third-party computing system(s) 108) and an additional computing system 302 (e.g., additional computing system 116). In particular, the network data analysis system 102 can perform act 310 to provide, for display on the client device 308, a risk classification analysis interface. In particular, the network data analysis system 102 can provide a risk classification analysis interface to provide information and receive requests associated with the classification analysis of network traffic data.

In some aspects, based on an interaction of the client device with the risk classification interface, the network data analysis system 102 can cause a server system 306 (e.g., server system 104 including the network data analysis system 102) to perform act 312 to capture network traffic data. In particular, the network data analysis system 102 can cause the server system 306 to capture network traffic data of request payloads or response payloads resulting from application programming interface (API) calls between the third-party computing system 304 and the additional computing system 302. As shown, the server system 306 captures network traffic data associated with the request payload 314, response payload 316, request payload 318, and response payload 320. Accordingly, the server system 306 can capture network traffic data sent to and received by the third-party computing system 304 based on requests originating from the third-party computing system 304 and/or the additional computing system 302. In some aspects, the network data analysis system 102 causes the third-party computing system 304 or another device in communication with the third-party computing system 304 (e.g., the server system 306 itself or another server device that is part of the server system 104) to execute one or more API calls resulting in the request/response payloads.

As indicated above, the network data analysis system 102 can extract data elements from captured network traffic data from the third-party computing system 304. In particular, the network data analysis system 102 can capture (e.g., collect, identify, or recover) network data elements from the request payloads and/or the response payloads between the third-party computing system 304 and the additional computing system 302. For example, the network data analysis system 102 can identify the payloads resulting from API calls and extract data elements (e.g., name, date of birth, SSN, address, medical history) from the network traffic data. For example, the network data analysis system 102 can extract an SSN data element from a payload by identifying SSNs containing numbers formatted as NNN-NN-NNN, based on a specific metadata tag identifying the SSN data element in the payload, and/or based on expected data returned using a specific API call according to an API specification.

In some aspects, the network data analysis system 102 performs a data extraction by retrieving data from the third-party computing system 304 based on a specific request from the server system 306 (e.g., act 312). In additional or alternative aspects, the network data analysis system 102 can implement a scanning frequency which defines how often the network data analysis system 102 captures network traffic data from the third-party computing system 304. In such aspects, the network data analysis system 102 captures a defined amount of data from the third-party computing system 304 based on a configuration indicated via the risk classification analysis interface. In additional or alternative aspects, the network data analysis system 102 captures network traffic data at set times. Moreover, in certain aspects, the network data analysis system 102 stores information (e.g., logs) associated with a scan of the third-party computing system 304.

As mentioned, the network data analysis system 102 can capture data using a machine-learning model. In some implementations the network data analysis system 102 utilizes network traffic data capture methods including, but not limited to, structured query language (SQL), application programming interfaces (APIs), web scraping, ETL, text mining and natural language processing (NLP) and/or image and video processing. In some aspects, the network data analysis system 102 uses credentials provided by the third-party computing system 304 to access various computing or software components to capture the network traffic data. In some aspects, the network data analysis system 102 uses dummy credentials to perform one or more operations associated with capturing network traffic data.

To illustrate, as shown in FIG. 3, the network data analysis system 102 captures network traffic data between the third-party computing system 304 and the additional computing system 302. As an example, the additional computing system 302 hosting a healthcare application initiates a request to the third-party computing system 304 from a doctor to retrieve patient medical records as an HTTP GET request for an API endpoint comprising query parameters, authentication credentials, and other data (e.g., request payload 314). In turn, the third-party computing system 304 responds with a HTTP 200 OK status and a JSON payload containing the patient PII, such as name, date of birth, and medical history (e.g., response payload 316). After receiving the patient data, the doctor sends an update for the patient treatment plan utilizing the third-party computing system 304 with a HTTP POST request for an API endpoint of the additional computing system 302 (e.g., request payload 318). In response, the additional computing system responds with an HTTP 200 OK status and a JSON payload confirming receipt of the patient treatment plan (e.g., response payload 320).

As further shown in FIG. 3, the network data analysis system 102 performs an act 322 to classify the network traffic data (e.g., request payload 314, response payload 316, request payload 318, response payload 320). In some aspects, the network data analysis system 102 utilizes one or more classifier models to classify data elements of the network traffic data between the third-party computing system 304 and the additional computing system 302. For example, the network data analysis system 102 utilizes the classifier models to analyze the metadata and/or payload data from the network traffic data and generate suggested classifications. For example, the network data analysis system 102 utilizes a classification model to determine data elements within the network traffic data that correspond to data types associated with one or more data policies.

To illustrate, the network data analysis system 102 can utilize a classifier model to analyze the payloads of the network traffic data to identify a particular classification for a data element set that includes one or more data elements. In some aspects, the network data analysis system 102 can utilize a classifier model to analyze data elements (or properties of the data elements) within the network traffic data to identify a particular classification for the data element set. For example, the network data analysis system 102 can utilize the classification model to determine that a “Social Security Number” data element is found in the network traffic data by analyzing the payload (e.g., transport layer). To illustrate, the network data analysis system 102 can analyze the structure of data in the payload (e.g., a number formatted as NNN-NN-NNNN) to generate a predicted classification of “SSN” for the data in the data source.

As further shown, the network data analysis system 102 can perform the act 324 to generate a classification analysis for the classifications of the network data. For example, the network data analysis system 102 can determine risk levels for the data types in the network traffic data. For example, the network data analysis system 102 can determine risk levels associated with each data type. For example, a data type without restrictions can be associated with a low risk level, while a data type with a set of restrictions could be associated with a higher risk level. To illustrate, the network data analysis system 102 can determine a high-risk data type includes data types that require stringent protection measures (e.g., social security numbers, credit card information, and health records), medium-risk data types include data that require moderate security measures (e.g., email addresses and phone numbers), and low-risk data types include less sensitive information (e.g., general names or non-PII data).

In some aspects, the network data analysis system 102 aggregates the network traffic data. In particular, the network data analysis system 102 can aggregate the network traffic data to identify the prevalence of each data type and potential patterns within the network traffic data. In addition, by aggregating the data types, the network data analysis system 102 can provide aggregated data to the client device (via the risk classification interface) to quickly identify common data risk levels and potential outliers.

As shown in FIG. 3, the network data analysis system 102 performs the act 326 to display the risk classification analysis. In particular, the network data analysis system 102 provides the classification analysis to the client device 308 for display via a graphical user interface. In some aspects, the network data analysis system 102 utilizes a color-coded risk level dashboard comprising the indications of a risk level set, which can include one or more risk levels, displayed in colors based on criteria comprising a probability of a risk occurrence, an impact severity of the risk occurrence, or an urgency of a risk remediation. Indeed, the network data analysis system 102 can utilize visualization tools (e.g., bar charts, pie charts) to present the prevalence of each data type and highlight the different risk levels.

For example, the network data analysis system 102 can provide the classification analysis of the network traffic data to the client device 308. The classification analysis can include risk levels for PII contained in the response payload 316 associated with requirements of a data policy. For example, by classifying the data types and assessing the security measures applied to it in relation to the data policy, the network data analysis system 102 can provide a comprehensive classification analysis based on the sensitivity of the information and the level of protection within the network traffic data. To illustrate, the classification analysis can determine a low risk level for the name, a medium risk level for the data of birth, and a high risk level for an unencrypted medical history in the response payload 316. Alternatively, if the data is encrypted, the classification analysis can determine a low risk level for the name, a low risk level for the date of birth, and a low risk level for the medical history in the response payload 316.

As also shown, the network data analysis system 102 can perform act 328 to update a computing operation on the third-party computing system 304. In particular, the network data analysis system 102 can automate the notification of risks to the third-party computing system 304. For example, the network data analysis system 102 can suggest or enact security measures to mitigate identified risks within the network traffic data. In some aspects, the network data analysis system 102 can provide an alert to the client device 308 and/or third-party computing system 304 based on a risk level exceeding a specified level (or threshold). Furthermore, in certain aspects, the network data analysis system 102 can provide data associated with the identified risk levels to the client device 308 and/or the third-party computing system 304 including data type, risk level, associated data policy requirement, API payload, an associated network interaction, frontend data (user interface), backend data (transport layer), and recommended action.

In some aspects, the network data analysis system 102 can implement an automatic block of certain technologies (e.g., cookies, application) based on the classification analysis. For example, on computing systems that the network data analysis system 102 has authorization to modify, the network data analysis system 102 can filter out insecure technologies and/or implement changes. In some aspects, the network data analysis system 102 can utilize proxy servers to filter data elements and/or data types based on the risk levels identified within the network traffic data. Additionally, in some aspects, the network data analysis system 102 can automatically block the third-party computing system 304 from executing a specific API call in response to detecting a specific risk associated with the API call until the risk is remediated.

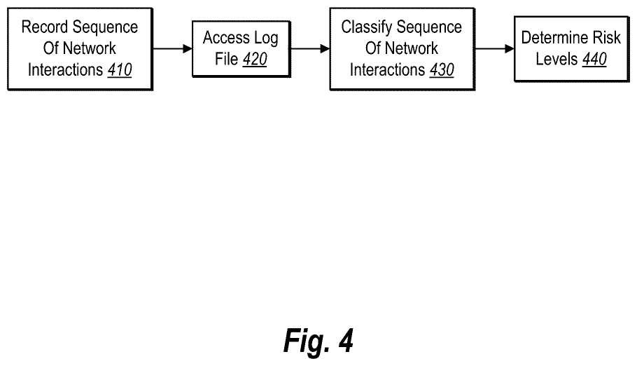

In some aspects, the network data analysis system 102 can record network requests and responses associated the sequence of network interactions and determine risk levels associated with the sequence of recorded network interactions. FIG. 4 illustrates an example of determining risk levels for network traffic data extracted from a log file in accordance with some aspects. For example, the log file can represent a typical user journey within an interface or set of interfaces while visiting a website.

As shown in FIG. 4, in some aspects, the network data analysis system 102 can use a recorded sequence of network interactions to determine risk levels. In particular, the network data analysis system 102 (or another system or device) can perform an act 410 to record a sequence of network interactions in a log file (e.g., a HAR file). To illustrate, a client device can record a sequence of network reactions associated with a web application such as logging in, clicking on links, and submitting forms. Furthermore, the network data analysis system 102 can save the recorded sequence of network interactions into a log file. In certain aspects, the network data analysis system 102 can receive a log file that comprises a recorded sequence of network interactions between computing systems.

Furthermore, the network data analysis system 102 can perform act 420 to access the log file to analyze the recorded network traffic data. In particular, the network data analysis system 102 can receive a request (e.g., from a client device) to analyze the recorded network traffic data within the log file to determine risk levels. To illustrate the network data analysis system 102 can parse the entries in the log file to extract the details of each network request and network response including one or more computing operations that result in request payloads or response payloads comprising network traffic data.

As shown in FIG. 4, the network data analysis system 102 can perform act 430 to classify the network traffic data for the sequence of network interactions. In particular, the network data analysis system 102 can utilize a classification model to classify the content of the network traffic data based on one or more data policies. For example, the network data analysis system 102 can identify and classify data types (such as email addresses, names, and credit cards) within the network traffic data.

The network data analysis system 102 can further perform act 440 to determine risk levels associated with the network interactions recorded in the log file. In particular, the network data analysis system 102 can establish criteria for different risk levels based on the sensitivity of the data types identified in the network traffic data and the requirements of the data policies. For example, the network data analysis system 102 can determine risk levels such as low risk, medium risk, and high risk. In some aspects, the network data analysis system 102 can assign a risk level for each classified data element in the network interactions.

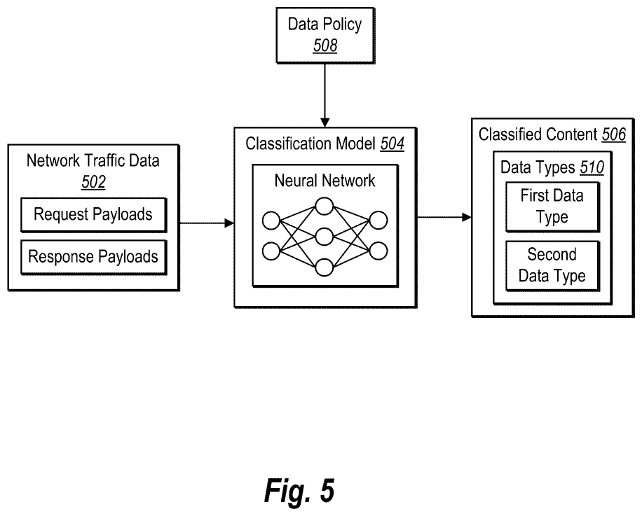

As mentioned, the network data analysis system 102 utilizes a classification model to classify content within network traffic data. FIG. 5 illustrates an example of utilizing a classification model in accordance with some aspects.

As shown in FIG. 5, the network data analysis system 102 captures network traffic data 502 to determine a network traffic data classification. As mentioned, the network data analysis system 102 extracts the payloads from the network packets within the network traffic data. In particular, the network data analysis system 102 captures the network traffic data 502 and classified data elements within the request payloads and response payloads.

As shown, in some aspects, the network data analysis system 102 utilizes a data policy 508 to classify the network traffic data 502. In some aspects, the data policy 508 includes requirements for specific data types based on data protection and compliance with standards including restrictions for data handling, storage, and transmission. For example, the data policy 508 can specify the security measures associated with sensitive information such as personally identifiable information (PII), financial data, and health records. In some aspects, the data policy 508 can require email addresses, phone numbers, and names to be encrypted during transmission. In some aspects, the data policy 508 can include stricter requirements for sensitive data types, such as social security numbers, credit card information, and medical records such as both encryption and multi-factor authentication. The data policy 508 can also define requirements for data minimization, requiring that only necessary data is collected and retained, and outline protocols for data breach notifications and response.

To illustrate, the network data analysis system 102 utilizes requirements determined by the data policy 508 such as data transmission requirements associated with user privacy, data security, and/or data sovereignty. In some aspects, the data policy 508 comprises regulatory requirements such as the General Data Protection Regulation (GDPR) or the California Consumer Privacy Act (CPA) which include requirements for how PII must be handled and protected within network traffic data. In some aspects, the data policy 508 comprises security measure requirements such as the Payment Card Industry Data Security Standard (PCI DSS) when transmitting cardholder data. In some aspects, the data policy 508 corresponds to entity specific regulations for data security and data privacy.

As shown, in some aspects, the network data analysis system 102 utilizes a classification model 504 (e.g., a classification neural network) to determine classifications for data types within the network traffic data associated with a data policy 508. In particular, the classification model 504 determines classified content 506 of data types 510, indicating the data types for the data elements of the network traffic data corresponding to the data policy 508. For example, the classification model 504 can determine data types that are associated with public, private, confidential, restricted, regulated, and/or sensitive data. In some aspects, the classification model 504 can provide detailed classifications such as “john.doe@example.com” as email and “1234-5678-9012-3456” as a credit card number.

The network data analysis system 102 can categorize the network traffic data in various ways to manage and protect information more effectively. For example, the network data analysis system 102 can utilize sensitivity-based categorizations including confidential data (e.g., trade secrets and proprietary business information), restricted data (e.g., internal audit reports and legal documents), and public data (e.g., press releases and marketing materials). In some aspects, the network data analysis system 102 utilizes source-based categorizations (e.g., internal data, external data), usage-based categorizations (e.g., operational data, analytical data), compliance-based categorizations (e.g., regulated data, non-regulated data), lifecycle-based categorizations (e.g., active data, archived data, temporary data), access-based categorizations (e.g., public, private shared), impact-based categorizations (e.g., high, moderate, low), and/or criticality-based categorizations (mission-critical, business-critical, non-critical).

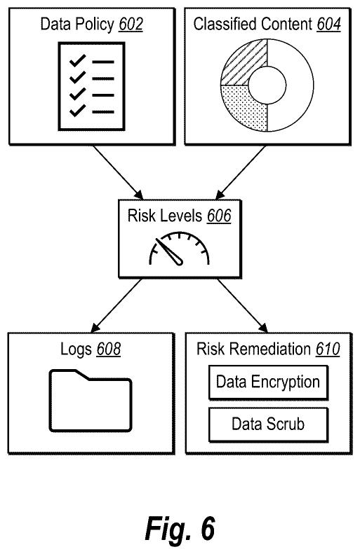

Turning now to FIG. 6, the network data analysis system 102 can determine risk levels 606 for the classified content 604. FIG. 6 illustrates an example of determining and utilizing risk levels 606 in accordance with some aspects. In particular, the network data analysis system 102 can determine the risk levels 606 by associating the classified content 604 with requirements of the data policy 602. For example, the network data analysis system 102 can determine risk levels by evaluating the actions required for each data type and assessing whether those actions have been implemented within the network traffic data.

To illustrate, once network data analysis system 102 classifies the data types within the network traffic data to determine the classified content 604, the network data analysis system 102 associates the classifications with the requirements of the data policy 602. For example, the data policy 602 provides requirements for handling data types such as requirements for data encryption, access control, and logging. In some aspects, the network data analysis system 102 analyzes the network traffic data to check if these requirements have been correctly implemented within the network traffic data. For example, if the data policy 602 mandates encryption for email addresses and social security numbers, the network data analysis system 102 determines whether these data types are encrypted. Based on this analysis, the network data analysis system 102 assigns risk levels: data types with all required protections in place can be assigned a low risk, while those lacking required security measures can be assigned a higher risk.

In some aspects, the network data analysis system 102 utilizes risk levels of high, medium, and low. For example, the network data analysis system 102 determines a high risk level for the non-compliance with requirements of the data policy 602 for a data type that could lead to severe financial loss, legal repercussions, significant reputational damage, or substantial harm. In some aspects, the network data analysis system 102 identifies certain data types at a high risk level based on non-compliance with the requirements of the data policy 602 including SSNs, credit card information, medical records, PII, and passwords. Furthermore, the network data analysis system 102 determines a medium risk level for the non-compliance with requirements of a data policy 602 for a data type that, while sensitive, may not lead to as severe consequences if exposed as high risk data types. In some aspects, the network data analysis system 102 identifies certain data types at a medium risk level based on non-compliance with the requirements of the data policy 602 including email addresses, phone numbers, transaction histories, and usernames. Moreover, the network data analysis system 102 determines a low risk level for a data type that is generally public or non-sensitive in nature or that represents data generally sent or received in connection with API calls. In some aspects, the network data analysis system 102 identifies certain data types at a low risk level including publicly available information, general business information, website URLs, and general announcements.

In some aspects, the network data analysis system 102 utilizes risk thresholds. For example, the network data analysis system 102 utilizes boundaries that, when exceeded classify the risk into risk level categorizations as described above. For example, if the network data analysis system 102 detects more than 5 instances of unencrypted sensitive data, the network data analysis system 102 can determine the risk level exceeds a risk threshold for high risk. Alternatively, if the network data analysis system 102 detects 1 instance of unencrypted sensitive data, the network data analysis system 102 can determine the risk level does not exceed a threshold for high risk.

As shown in FIG. 6, the network data analysis system 102 generates logs 608 of the risk levels 606. In particular, the network data analysis system 102 can record the risk levels 606 and associated information such as the data type, data content, network transmission, transmission source, transmission destination, timestamp, alerts, actions taken, and recommended actions. In some aspects, the network data analysis system 102 provides the logs 608 to a client device for display in a graphical user interface.

In some aspects, the network data analysis system 102 utilizes the logs 608 to determine patterns or changes in the risk levels for the network transmission data. For example, the network data analysis system 102 can determine a first risk level for content of network traffic data captured in connection with a first sequence of network transmissions and a second risk level for content of network traffic data captured during a second sequence of network transmissions. Furthermore, the network data analysis system 102 can determine a risk delta corresponding to the change in the risk level of the data types in the network transmissions (e.g., a difference between the first risk level and the second risk level). In some aspects, the network data analysis system 102 can monitor the network traffic data for risk patterns indicating potential security issues, such as capturing multiple high risk level data types within a specified time period. In some aspects, the network data analysis system 102 can provide, for display via the graphical user interface of a client device, the risk delta and/or risk pattern in conjunction with information associated with the network transmissions.

As shown, in some aspects, the network data analysis system 102 determines a risk remediation 610 based on the risk levels 606. For example, the network data analysis system 102 recommends or enacts risk remediation 610 based on the risk levels 606. For example, for high risk levels, the network data analysis system 102 sends an alert to a computing system (e.g., email, SMS, dashboard, application, log). In addition, the network data analysis system 102 can provide recommendations to alleviate the risk levels based on the requirements of the data policy 602. In some aspects, the network data analysis system 102 enacts or recommends actions to one or more computing systems such as data minimization, data scrubbing, data encryption, multi-factor authentication, API endpoint or API call modification, cookie removal, cookie disabling, and/or data anonymization.

FIG. 7 illustrates an example of a system architecture of the network data analysis system 102 executing a classification analysis of network traffic data in accordance with some aspects. As shown, FIG. 7 illustrates an example architecture of the network data analysis system 102 performing operations to classify network traffic data transmitted between computing systems. In some aspects, as illustrated, a first portion of the network data analysis system 102 operates at a cloud-based computing system. Additionally, a second portion of the network data analysis system 102 operates on premises (e.g., on one or more computing devices or servers associated with an entity, a shared processing infrastructure, or both).

In some aspects, the network data analysis system 102 includes an administrator client device 702 that initiates a classification analysis request 704 to analyze and classify data elements within network traffic data transmitted between a plurality of entities such as request payloads, response payloads, cookies, tags, and/or metadata. In some aspects, the classification analysis request 704 includes API configurations or API endpoints.

In some aspects, the network data analysis system 102 determines a policy profile 706 indicating one or more requirements for classifying the data types within the network traffic data according to one or more data policies. Furthermore, in some aspects, the policy profile 706 includes (or is otherwise based on) a classification profile 708 indicating risk levels for classified content from the network traffic data, for example, as determined by the network data analysis system 102. As also illustrated, in some aspects, the network data analysis system 102 provides the policy profile 706 to classification analysis control 710 that initiates the classification analysis request in connection with a portion of the network data analysis system 102 at computing devices of the entity.

In some aspects, an electronic request from a computing system includes a request sent to the network data analysis system 102 (e.g., via an API provided by the network data analysis system 102) and including processing instructions to perform one or more operations via one or more recipient processors and/or processing threads. For instance, a classification analysis request can include a request to capture data, extract data, classify data, modify data, or otherwise perform operations on data for one or more entities of a webpage/domain.

In additional aspects, the network data analysis system 102 utilizes the classification analysis control 710 to provide the classification analysis request 704 with the policy profile 706 to a synchronizing system 712 at computing devices of the entity. For instance, the synchronizing system 712 can continuously poll the classification analysis control 710 for new classification analysis requests. In some aspects, the synchronizing system 712 provides the classification profile 708 for inclusion with the policy profile 706. As illustrated in FIG. 7, the network data analysis system 102 deploys the synchronizing system 712 (with additional components) at the computing device(s) of the entity behind network security controls (e.g., outside one or more firewalls) for accessing entities associated with webpages/domains (e.g., at the computing devices or via one or more remote computing devices through the firewall(s)).

For instance, in the example depicted in FIG. 1, the synchronizing system 712 (with additional components) could be installed on the server system 104 within a computing environment managed or accessed via one or more administrator client devices. In this example, the network data analysis system 102 includes the classification analysis control 710 and the synchronizing system 712. The classification analysis control 710, installed on a client device 106, can only communicate with the synchronizing system 712, installed on the client device 106, whereas the synchronizing system 712 (with additional components) can perform various analysis and classification actions described herein.

In some aspects, the network data analysis system 102 utilizes the synchronizing system 712 to compare a list of analysis jobs to determine one or more actions to take. For example, in response to determining that a classification analysis request is present on the cloud-based system but not on the on-premises system, the synchronizing system 712 initiates a new analysis job. In response to determining that a classification analysis request is present on the on-premises system but not on the cloud-based system, the synchronizing system 712 cancels the classification job on the on-premises system. If the synchronizing system 712 determines that a classification analysis request is present on both systems, the synchronizing system 712 determines a status of the classification analysis request (e.g., completed, failed, or timed-out) and sends a status notification to the classification analysis control 710.

In some aspects, the network data analysis system 102 utilizes the synchronizing system 712 to submit a classification analysis job request 714 to a classification analysis job manager 716 that manages the initiation and execution of classification analysis job requests at the computing device(s) of the entity and/or via a shared processing infrastructure. For example, the network data analysis system 102 utilizes the classification analysis job manager 716 to communicate with classification analysis systems 718 that capture network traffic data for the classification analysis job request 714 by leveraging the parallel processing and publishing infrastructure of the shared processing infrastructure. In additional aspects, the classification analysis systems 718 includes a network traffic monitor 720 that executes functions, scripts, or applications to capture or extract network traffic data. To illustrate, the classification analysis systems 718 communicate with computing devices (e.g., utilizing credentials in a credentials storage 722) to access network transmissions for webpages/domains. In some aspects, a listing of classification analysis jobs received from the classification analysis control 710 can include job contexts for each classification analysis job request.

In some aspects, the network data analysis system 102 executes a classification analysis job through a pipeline of initiation, distribution, extraction, and classification implemented by the classification analysis systems 718 on the on-premises system, in which various events are emitted at different stages. Events can include examples such as those in the table below.

JOB_DISTRIBUTION_STARTED
JOB_CANCELLED
INCREMENT_JOB_SIZE
JOB_DISTRIBUTION_COMPLETED
JOB_DISTRIBUTION_FAILED
TASK_STARTED
UPDATE_TASK_SIZE
INCREMENT_PROCESSED_SIZE
TASK_COMPLETED
TASK_FAILED
TASK_CANCELLED

The classification analysis job manager 716 can subscribe to the events and manage the lifecycle of the jobs/tasks based on those events. Additionally, classification analysis systems 718 can emit events upon completion of a particular phase of the scan job in a pipeline. In some aspects, the classification analysis job manager 716 updates a jobs repository to indicate which of these events have been emitted for a given classification analysis job.

Furthermore, as illustrated, the classification analysis systems 718 include a classification analysis library 724 that communicates with a classification model 726 (e.g., a neural network or other classification algorithm model) to determine classifications associated with the network traffic data. In some aspects, a classification model 726 can be implemented using one or more classification analysis features described above with respect to FIGS. 2-6. Additionally, the classification analysis library 724 can determine classifications according to information from the policy profile 706 and the classification profile 708.

In some aspects, in response to executing the classification analysis job request 714 utilizing the classification analysis systems 718, the network data analysis system 102 utilizes the classification analysis systems 718 to communicate results data to the synchronizing system 712. For example, the classification analysis systems 718 can provide classification results corresponding to the digital content items indicated in the classification analysis job request 714 to the synchronizing system 712. Additionally, as illustrated, the synchronizing system 712 can provide the classification results to the classification analysis control 710, which provides the results 728 for display and analysis via one or more client devices (e.g., the administrator client device 702).

In some aspects, the network data analysis system 102 provides the results 728 in connection with one or more downstream operations. The downstream operations can involve one or more computing devices (e.g., the administrator client device 702 or another device/system) performing operations to classify specific data types within the network traffic data, manage network traffic data via automated workflows, control access to network traffic data, and/or facilitate deletion of network traffic data. To illustrate, the network data analysis system 102 can detect a new type/classification of digital content items (e.g., personal data or sensitive data) transmitted in the network traffic data, which triggers an automated workflow via a software platform that includes or has access to the network traffic data. The automated workflow can include a series of user interfaces that are dynamically selected, generated, organized, or otherwise configured based on the classification analysis workflow.

An example of the workflow includes the classification and assessment of network traffic data (e.g., via one or more software modules of the platform) in which a series of user interfaces for classifying information (e.g., information regarding one or more of the data sources, the discovered data, the use of the discovered data, etc.) are displayed to a user. The network data analysis system 102 (or another system) can dynamically categorize content items for display on a series of interfaces based on the classifications of the content of the network traffic data (e.g., selecting interfaces presenting violations related to privacy issues for certain content) and the data received via various interfaces in the workflow (e.g., providing options to resolve or revalidate network transmissions).

In some aspects, the network data analysis system 102 (or another system) can dynamically identify risk levels associated with categorized network traffic data. Furthermore, the system may utilize the automated workflow to notify appropriate users of the risk levels, implement appropriate steps to remediate risk levels (e.g., violations of a data policy), or monitor the network transmissions based on the categorized network traffic data for potential security/privacy risks. Accordingly, the network data analysis system 102 can execute a risk remediation in response to one or more user inputs or automatically in response to detecting a classification within the network traffic data and execute an automated workflow to perform one or more computing operations based on the assessment and/or otherwise in connection with detecting the classification.

Additionally, or alternatively, the network data analysis system 102 determines classifications for network traffic data and uses the determined classifications to implement risk remediation. For instance, the network data analysis system 102 can determine that certain network transmissions (e.g., web form data) may be subject to a particular data policy for managing the data. To illustrate, a computing system may manage credit card data or other financial data to use in processing a purchase for a first data subject via a website. In such an example, the credit card data (e.g., entire credit card number and security code) may not necessarily be transmitted for security purpose and a portion of the credit card data may be transmitted. Therefore, the computing system may determine specific requirements for the credit card data based on the different purposes associated with the transmission requirements for the credit card data.

In an additional example, the computing system may receive a second request for credit card data to use in displaying to a second data subject on the website to remind the second data subject of the credit card data previously saved to use in purchases. In such an example, the credit card data (e.g., entire credit card number) may not necessarily be needed for display to the second data subject, while a portion of the credit card data (e.g., a partially obfuscated or modified credit card number) may be sufficient for identification by the data subject. Therefore, the computing system, which can be included in or communicate with the network data analysis system 102, may determine specific transmission controls for the credit card data based on the different purposes associated with the requests for the credit card data. Such transmission controls may not only be applicable with respect to how the data is displayed but may also be applicable to how the data is transmitted.

In either case, improved methods for analyzing and classifying data transmitted in network traffic data (i.e., determining that the network traffic data includes credit card data) by the network data analysis system 102 facilitates the application of data policies (e.g., which implement certain purpose restrictions) that selectively modify network transmissions returned in response to a network query so that the content of the network traffic data is compliant with the purpose restrictions implemented via the data policies. For instance, a user of the computing environment that includes the network transmissions may have an account with a certain role that is assigned certain access permissions. The permissions may allow access to certain types of data in certain types of network transmissions for certain purposes associated with the role. Thus, the network data analysis system 102 facilitates purpose-based access control to network traffic data based on the classification applied to the network traffic data. This ensures that the personal data is only accessed by authorized users (e.g., user accounts) for authorized purposes.

Additionally, or alternatively, the network data analysis system 102 assists in the automated detection and remediation of network traffic data that violates data policies. For example, the network data analysis system 102 detects (or is used by the network data analysis system 102 to detect) a certain type of data transmitted in network traffic data, such as personal data or other data considered sensitive for legal, regulatory, or policy reasons. A software program or suite that includes the network data analysis system 102 or that communicates with the network data analysis system 102 (e.g., via an integration between the software program and the network data analysis system 102) can automatically delete, modify, or block (or automatically prompt a user to delete, modify or block) the network transmissions that violate the data policy.

For example, the network data analysis system 102 may determine that network traffic data contains emails with unmasked SSNs, violating a data policy. A software program that has access to the network data analysis system 102 (e.g., via an integration between the software program and the network data analysis system 102) may automatically modify the emails, by replacing the SSNs with masked versions (e.g., “XXX-XX-1234”). The network data analysis system 102 may automate the modification (e.g., without requiring any user intervention) or partially automate the modification (e.g., by presenting a user with a prompt or screen identifying the data to be deleted and proceeding with the deletion upon receiving the user's confirmation).

Although FIG. 7 illustrates that the network data analysis system 102 utilizes a plurality of components within a cloud-based system and a plurality of components at on premises devices of a single entity, the network data analysis system 102 can implement data classification analysis for a plurality of entity devices. To illustrate, the network data analysis system 102 can integrate separate synchronizing systems, classification analysis job managers, and classification analysis systems at computing devices of each entity that issues a classification analysis request to the components within the cloud-based system. For instance, the network data analysis system 102 can utilize the classification analysis control 710 to manage classification analysis requests for a plurality of entity devices and communicate with a plurality of separate synchronizing systems at different computing devices of the different entity devices.

Additionally, as mentioned above, the network data analysis system 102 can utilize a first set of operations to manage a policy profile 706 and a classification analysis control 710 for implementing a classification analysis request 704 and providing results 728 of the classification analysis request 704 via the administrator client device 702 at a first computing system (e.g., a cloud-based computing system) while communicating with a shared processing infrastructure. Additionally, the network data analysis system 102 can utilize a second set of operations to manage a synchronizing system 712, a classification analysis job manager 716, and classification analysis systems 718 to classify data utilizing a classification model 726 at a second computing system (e.g., one or more computing devices or servers at one or more locations of an entity) while communicating with the shared processing infrastructure.

In some aspects, the network data analysis system 102 utilizes one or more other configurations, such that one or more portions described above in connection with the first computing system are instead part of the second computing system, or vice-versa. Thus, the network data analysis system 102 can utilize several different computing devices (e.g., cloud-based devices or on premises devices) to perform various operations associated with analyzing and classifying network traffic data. In additional aspects, the network data analysis system 102 performs one or more operations described herein by utilizing one or more software applications at one or more computing devices to generate instructions that cause one or more additional computing devices to perform one or more computing operations. As an example, a cloud-based computing application classifies network traffic data by generating instructions that cause a server on premises of an organizational entity to utilize a classification model to generate a classification for network traffic data for a webpage/domain.

In some aspects, the components deployed on the computing device(s) of the entity are part of a discovery agent for detecting data sources, datasets, and data types via data extraction and classification. The network data analysis system 102 can utilize the discovery agent to identify a data source, scan the data source, tag the data source (e.g., tag data in the data source), and send and classify the respective set of data in accordance with the tagged data. In some instances, by utilizing the discovery agent, the network data analysis system 102 generates metadata associated with the digital content items to indicate results of the identification and classification by the discovery agent. Additionally, the discovery agent can include one or more virtual machines for storing data and/or including/executing scanning operations or classifying operations.

In additional aspects, the network data analysis system 102 configures the discovery agent to reduce an impact on a performance of the computing devices, servers, etc. For instance, the network data analysis system 102 can configure the discovery agent to utilize bandwidth throttling techniques, such as by limiting scanning and other processing steps to non-peak times. The network data analysis system 102 can also configure the discovery agent to limit performance of such operations to through distributed sampling (e.g., by using distributed sampling techniques to decrease a number of files to scan during the data discovery process).

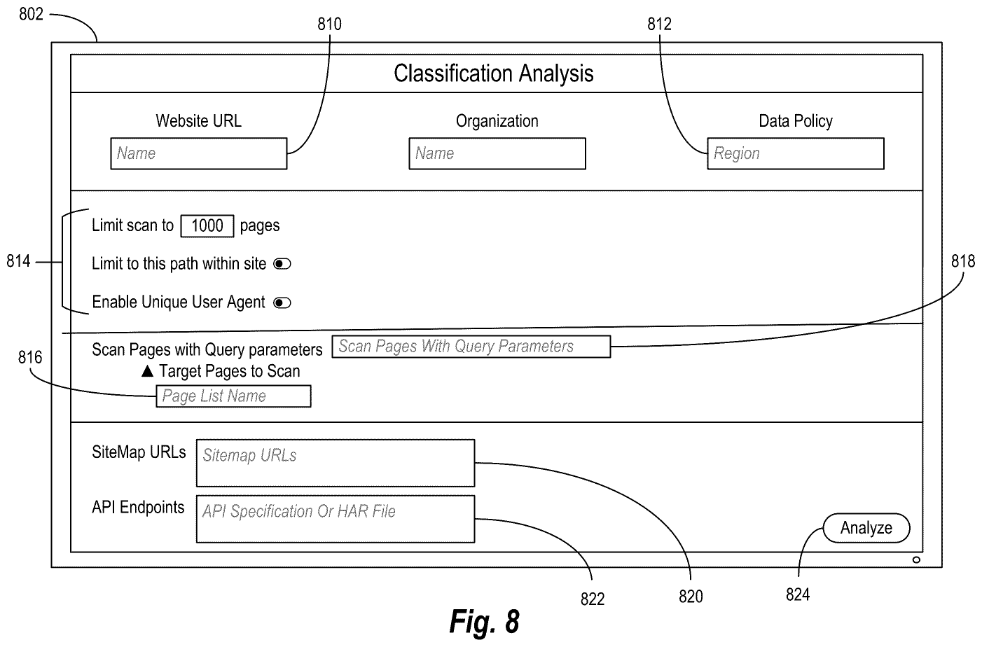

As mentioned above, the network data analysis system 102 can provide information associated with network traffic data and risk levels for display via graphical user interfaces of client devices. FIGS. 8-10 illustrate graphical user interfaces of client devices for initiating and managing classification analysis requests for network traffic data associated with an entity. For example, FIG. 8 illustrates an example of a graphical user interface for requesting a classification analysis for a website in accordance with some aspects.

As illustrated in FIG. 8, the client device can display tools for performing a classification analysis associated with a network traffic data source and/or an entity. As shown, the network data analysis system 102 can perform the classification analysis based on an application interaction with selection 824. In particular, the graphical user interface 802 can include options to provide a classification analysis for network traffic data for one or more entities 810 (e.g., website URL). To illustrate, in response to determining a selection of one or more attributes, the network data analysis system 102 can apply the classifier model to selected portions of the network traffic data for the one or more entities 810. In some aspects, the client device can provide an option to utilize one or more data policies 812 (e.g., Data Policy) to establish requirements for classifying the network traffic data.

As also shown, the network data analysis system 102 can apply the classification analysis the selected portions of the network traffic data and/or provide options to restrict the classification analysis associated with an entity. For example, the network data analysis system 102 can provide options 814 to limit the capture of the network traffic data to a number of webpages, a specified path, or a specific user agent. As also shown, the network data analysis system 102 can limit the location of the pages within a website evaluated for the classification analysis. In some aspects, the network data analysis system 102 can perform the classification analysis utilizing query parameters 818 and/or a targeted path 816 (e.g., a specific subdomain or web page of a website). In some aspects, the network data analysis system 102 can utilize query parameters 818 such as parameters for searching, filtering, sorting, or authentication.

In some aspects, the network data analysis system 102 can provide a classification analysis based on parameters associated with a website configuration. For example, the network data analysis system 102 can receive a sitemap 820 (e.g., SiteMap URLs) comprising a listing of pages of a website and metadata about each webpage. By utilizing the sitemap 820, the network data analysis system 102 can efficiently navigate the structure of a website to capture associated network traffic data. Relatedly, in some aspects, the network data analysis system 102 can utilize an API endpoint 822 (or a set of API endpoints and/or an API specification) indicated in connection with the classification analysis. For example, the network data analysis system 102 can utilize the API endpoint 822 to generate and capture network traffic data between the network data analysis system 102 and a computing system, enabling the network data analysis system 102 to make targeted network transmission requests and receive responses for capturing network traffic data associated with a specific set of API calls.

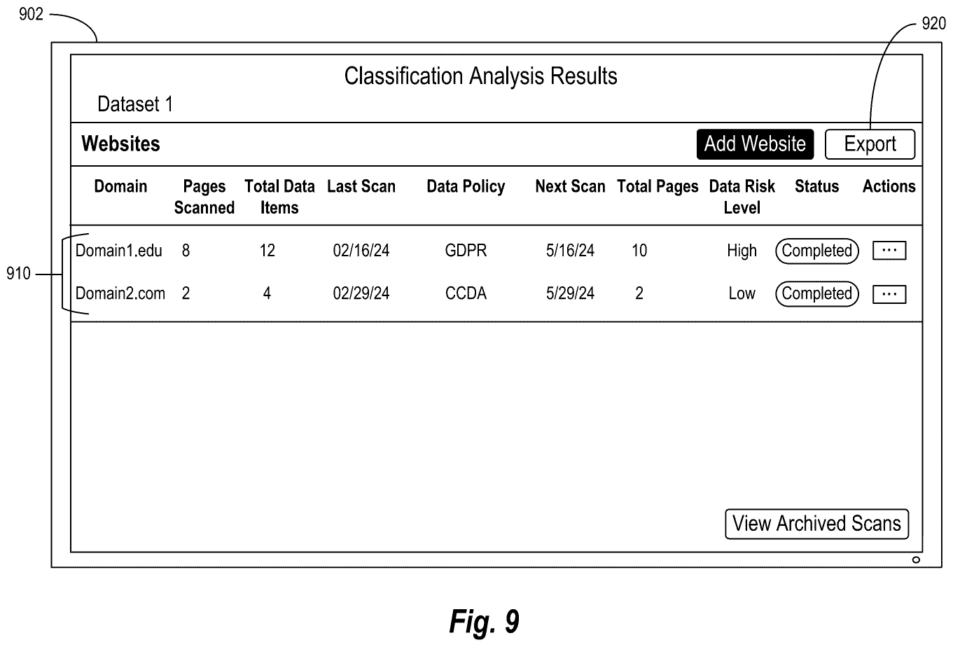

As mentioned, the network data analysis system 102 can provide the results of a classification analysis for display on a graphical user interface 902. As indicated above, in some aspects, the network data analysis system 102 can utilize a classifier model to classify network traffic data and provide a classification analysis for display at the client device. FIG. 9 illustrates an example of a graphical user interface displaying results of a classification analysis in accordance with some aspects.

As shown in FIG. 9, the network data analysis system 102 can provide a summary 910 of the classification analysis for one or more websites and/or computing systems. In some aspects, the network data analysis system 102 provides the summary 910 for domains associated with the classification analysis that includes a listing of the scanned pages, total data items, date of scan, data policy, date for next scan, total pages, data risk level, scan status, and recommended actions. In this way, the network data analysis system 102 provides a concise overview of the status of a classification analysis for multiple domains and the associated risk levels.

As further shown, the network data analysis system 102 provides an option 920 to export the classification analysis results. In some aspects, the network data analysis system 102 exports information about the classifications, data types, risk levels, content, and/or network traffic data. In some aspects, the network data analysis system 102 exports recommendations of actions to remediate violations of data policies in conjunction with the classification information. In some aspects, the network data analysis system 102 exports recommendations for data minimization, data scrubbing, data encryption, multi-factor authentication, API endpoint or API call modification, and/or data anonymization.

As mentioned, the network data analysis system 102 can provide the results of a classification analysis for display using a variety of visualization tools on a graphical user interface. As shown, the network data analysis system 102 can utilize a color-coded risk level dashboard comprising indications of risk levels displayed in colors based on criteria comprising a categorization of data types, a classification of data types, a probability of a risk occurrence, an impact severity of the risk occurrence, or an urgency of a risk remediation. As shown, the network data analysis system 102 can utilize visualization tools (e.g., bar charts, pie charts, box plots, area charts) to present the prevalence of each data type and highlight the different risk levels.

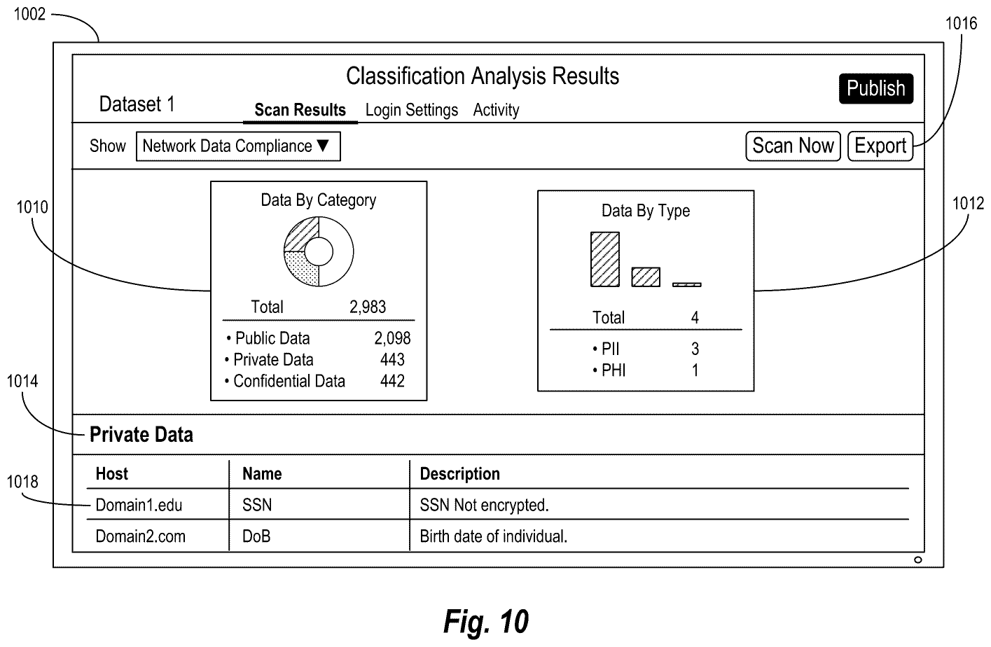

In some aspects, the network data analysis system 102 can provide a variety of information using visualization tools. FIG. 10 illustrates an example of a graphical user interface displaying results of a classification analysis using visualization tools in accordance with some aspects.

For example, the network data analysis system 102 can present the classifications of data types within the network traffic data for a computing system in various ways. In some aspects, the network data analysis system 102 provides a classification 1010 displaying data by category. In some aspects, the classification 1010 includes categories of data types within the network traffic data as relative amounts of the whole network traffic data in a pie chart. In some aspects, the classification 1010 includes an aggregation of the data types and/or a count of data elements associated with specific categories. As also shown, the network data analysis system 102 can provide the classification 1012. In some aspects, the network data analysis system 102 provides the classification 1012 as data by type in a bar graph to compare quantities across different data types. In some aspects, the classification 1012 includes an aggregation of the data types and/or a count of data elements associated with specific data types. In some aspects, the network data analysis system 102 utilizes colors to indicate high risk levels or draw attention to specific categories or data types.

As also shown, the network data analysis system 102 can provide detailed information 1014 for one or more types of data. For example, the network data analysis system 102 can classify data elements and provide information about an associated domain, data type, and description. In some aspects, the network data analysis system 102 provides detailed information 1014 that includes data identification, volume, frequency, sensitivity, source, destination, anomalies, patterns, compliance, encryption, context, associated risks, trends, or authentication. In some aspects, the network data analysis system 102 can receive user input indicating the information to provide for display on the graphical user interface 1002.

As mentioned, the network data analysis system 102 can export one or more items displayed on the graphical user interface 1002. For example, the network data analysis system 102 can export the private data element 1018 based on a user selection of the export element 1016. In some aspects, the network data analysis system 102 can export the classification 1010 and/or the classification 1012. In some aspects, the network data analysis system 102 can export the private data element 1018 by exporting an associated classification, risk level, content, and recommended actions. In this way, the network data analysis system 102 provides a method to remediate violations of the data policy by the private data element 1018.

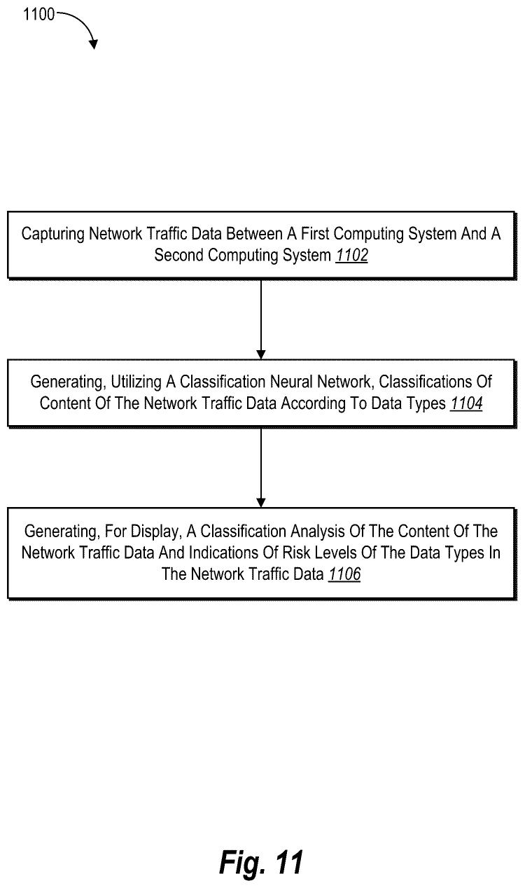

Turning now to FIG. 11, this figure illustrates an example flowchart of a method for providing a classification analysis of risk levels associated with network traffic data in accordance with some aspects. While FIG. 11 illustrates acts according to one aspect, alternative aspects may omit, add to, reorder, and/or modify any of the acts shown in FIG. 11. The acts of FIG. 11 can be performed as part of a method. Alternatively, a non-transitory computer readable medium can comprise instructions, that when executed by one or more processors, cause a computing device to perform the acts of FIG. 11. In still further aspects, a system can perform the acts of FIG. 11. One or more of these aspects can be implemented using a network data analysis system described in one or more of the examples above.

The process 1100 includes an act 1102 of capturing network traffic data between a first computing system and a second computing system. More specifically, the act 1102 includes capturing, by at least one hardware processor, network traffic data of request payloads or response payloads of application programming interface (API) calls in one or more network interactions between a computing system and an additional computing system. In some aspects, act 1102 is implemented using one or more examples described above with respect to FIGS. 1-5, such as by using the network data analysis system 102 to implement the extracting operations.

The process 1100 also includes an act 1104 of generating, utilizing a classification neural network, classifications of content of the network traffic data according to data types. In particular, the act 1104 includes generating, by the at least one hardware processor utilizing a classification neural network, classifications of content of the network traffic data for the computing system according to data types in the request payloads or the response payloads of the API calls. In some aspects, act 1104 is implemented by a network data analysis system using one or more examples described above with respect to FIGS. 1-5.

Additionally, the process 1100 includes an act 1106 of generating, for display, a classification analysis of the content of the network traffic data and indications of risk levels of the data types in the network traffic data. More specifically, the act 1106 includes generating, for display via a graphical user interface of a client device associated with the computing system, a classification analysis comprising the classifications of the content of the network traffic data and one or more indications of risk levels of the data types in the network traffic data. In some aspects, act 1106 is implemented by a network data analysis system using one or more examples described above with respect to FIGS. 2, 3, and 7.

Moreover, the process 1100 includes generating one or more classifications indicating first data without restrictions or second data associated with a set of restrictions. In one or more implementations, the process 1100 includes generating the one or more indications of risk levels comprising a first risk level for the first data or a second risk level for the second data, the second risk level indicating a higher risk level than the first risk level. The process 1100 includes determining that a risk level associated with a data type identified in the content of the network traffic data exceeds a risk threshold. In some cases, the process 1100 further includes generating, for display at the client device, a notification comprising the risk level and a description of the content of the network traffic data.

The process 1100 also includes determining, in response to a request comprising a log file by the client device, a sequence of network interactions comprising one or more computing operations that result in the request payloads or the response payloads comprising the network traffic data. In one or more cases, the process 1100 can include generating the classification analysis comprising the classifications of the content of the network traffic data by extracting the network traffic data from the log file. The process 1100 can include receiving, via the graphical user interface of the client device associated with the computing system, an API endpoint for a network interaction of the one or more network interactions. The process 1100 also includes capturing, the network traffic data by causing the computing system to execute the network interaction according to the API endpoint and monitoring a request payload or a response payload resulting from the network interaction to determine the network traffic data.

The process 1100 can include determining a first risk level for content of first network traffic data captured in connection with a first sequence of interactions. The process 1100 can also include determining a second risk level for content of second network traffic data captured during a second sequence of interactions. The process 1100 can further include generating, for display via the graphical user interface of the client device associated with the computing system, the classification analysis comprising a risk delta comprising a difference between the first risk level and the second risk level. The process 1100 includes determining requirement parameters comprising requirements of a data policy for handling specific data types for the one or more network interactions. The process 1100 can include determining the risk levels of the data types in the network traffic data by comparing the content of the network traffic data to the requirement parameters.

The process 1100 can also include determining, for a provided API endpoint, one or more expected data types for a response payload corresponding to a request payload of an API call. In some aspects, the process 1100 can include capturing the network traffic data comprising the response payload in response to sending the request payload of the API call. The process 1100 can also include generating, for display via the graphical user interface of the client device, an indication of the one or more expected data types extracted from the response payload.

The process 1100 can further include capturing network traffic data of request payloads or response payloads of the API calls in connection with the computing system hosting the website. The process 1100 includes generating, utilizing a classification neural network, classifications of content of the network traffic data according to data types in the request payloads or the response payloads of the API calls. In one or more cases, the process 1100 includes generating, for display via a graphical user interface of a client device associated with the computing system, a classification analysis comprising the classifications of the content of the network traffic data and indications of risk levels of the data types in the network traffic data.

The process 1100 can further include determining, from a log file comprising recorded computing operations, a sequence of interactions with the website comprising one or more computing operations that result in the request payloads or the response payloads comprising the network traffic data. Additionally, the process 1100 can include capturing the network traffic data from the sequence of interactions recorded in the log file. The process 1100 can include generating, for display via a graphical user interface of the client device associated with the computing system, a color-coded risk level dashboard comprising the indications of the risk levels displayed in colors based on criteria comprising a probability of a risk occurrence, an impact severity of the risk occurrence, or an urgency of a risk remediation.

The process 1100 can also include receiving, via the graphical user interface of the client device associated with the computing system, an API endpoint for a network interaction corresponding to a targeted path. In certain aspects, the process 1100 further includes capturing the network traffic data in response to the computing system executing the network interaction corresponding to the targeted path. Moreover, the process 1100 can include determining, for a provided API endpoint, an expected data type for a response payload corresponding to a request payload of an API call.

In one or more cases, the process 1100 includes capturing the network traffic data comprising the expected data type within the response payload in response to sending the request payload of the API call. The process 1100 can include generating, for display via the graphical user interface of the client device, a risk level associated with the network traffic data based on capturing the network traffic data comprising the expected data type. In some aspects, the process 1100 can include determining the risk levels of the data types in the network traffic data based on a data policy associated with the classifications of the content of the network traffic data. The process 1100 can further include generating, based on the risk levels, a recommendation to perform a remediation action comprising a modification associated with the computing system.

The process 1100 can also include capturing network traffic data of request payloads or response payloads of application programming interface calls in one or more network interactions between a computing system and an additional computing system. The process 1100 can include generating, utilizing a classification neural network, classifications of content of the network traffic data for the computing system according to data types in the request payloads or the response payloads of the application programming interface calls. In some cases, the process 1100 further includes determining one or more risk levels associated with classifications of the content of the network traffic data based on one or more sets of data requirements corresponding to the computing system. The process 1100 can also include causing, for the computing system, an update to a computing operation associated with the application programming interface calls in response to the one or more risk levels exceeding a risk threshold.

The process 1100 can further include generating the classifications of the content of the network traffic data by generating a classification for first data without restrictions or second data associated with a set of restrictions. Additionally, the process 1100 can include causing the computing system to update the computing operation by causing the computing system to update a computing operation to encrypt a portion of the content of the network traffic data or disable a cookie associated with the one or more network interactions. The process 1100 can also include determining the one or more risk levels associated with the classifications of the content of the network traffic data by comparing the content of the network traffic data to requirements of a data policy.

The process 1100 can include determining, based on recorded interactions in a log file, a sequence of network interactions comprising the one or more network interactions between the computing system and the additional computing system. The process 1100 can further include generating the classifications of the content the network traffic data by extracting the network traffic data from the log file for the sequence of network interactions. The process 1100 can further include capturing additional network traffic data of request payloads or response payloads of application programming interface calls in one or more additional network interactions between a first computing system and a second computing system. The process 1100 includes determining one or more additional risk levels for the one or more additional network interactions. In one or more cases, the process 1100 includes generating, for display via a graphical user interface of a client device associated with the computing system, a risk delta indicating a difference between the one or more risk levels and the one or more additional risk levels.

Aspects of the present disclosure may comprise or utilize a special purpose or general-purpose computer including computer hardware, such as, for example, one or more processors and system memory, as discussed in greater detail below. Aspects within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, aspects of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some aspects, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, the subject matter defined in the appended claims is not necessarily limited to the described features or acts described above. Rather, the described features and acts are disclosed as example forms of implementing the claims.

This disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Aspects of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 that may be configured to perform one or more of the processes described above. One or more computing devices such as the computing device 1200 may implement the system(s) of FIG. 1. The computing device 1200 can comprise a processor 1202, a memory 1204, a storage device 1206, an I/O interface 1208, and a communication interface 1210, which may be communicatively coupled by way of a communication infrastructure 1212. In certain aspects, the computing device 1200 can include fewer or more components than those shown in FIG. 12. Components of the computing device 1200 shown in FIG. 12 will now be described in additional detail.

In some aspects, the processor 1202 includes hardware for executing instructions, such as those making up a computer program. As an example, and not by way of limitation, to execute instructions for dynamically modifying workflows, the processor 1202 may retrieve (or fetch) the instructions from an internal register, an internal cache, the memory 1204, or the storage device 1206 and decode and execute them. The memory 1204 may be a volatile or non-volatile memory used for storing data, metadata, and programs for execution by the processor(s). The storage device 1206 includes storage, such as a hard disk, flash disk drive, or other digital storage device, for storing data or instructions for performing the methods described herein.

The I/O interface 1208 allows a user to provide input to, receive output from, and otherwise transfer data to and receive data from computing device 1200. The I/O interface 1208 may include a mouse, a keypad or a keyboard, a touch screen, a camera, an optical scanner, network interface, modem, other known I/O devices or a combination of such I/O interfaces. The I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain aspects, the I/O interface 1208 is configured to provide graphical data to a display for presentation to a user. The graphical data may be representative of one or more graphical user interfaces and/or any other graphical content as may serve a particular implementation.

The communication interface 1210 can include hardware, software, or both. In any event, the communication interface 1210 can provide one or more interfaces for communication (such as, for example, packet-based communication) between the computing device 1200 and one or more other computing devices or networks. As an example, and not by way of limitation, the communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1210 may facilitate communications with various types of wired or wireless networks. The communication interface 1210 may also facilitate communications using various communication protocols. The communication infrastructure 1212 may also include hardware, software, or both that couples components of the computing device 1200 to each other. For example, the communication interface 1210 may use one or more networks and/or protocols to enable a plurality of computing devices connected by a particular infrastructure to communicate with each other to perform some aspects of the processes described herein.

In the foregoing specification, the present disclosure has been described with reference to specific exemplary aspects thereof. Various aspects and aspects of the present disclosure(s) are described with reference to details discussed herein, and the accompanying drawings illustrate the various aspects. The description above and drawings are illustrative of the disclosure and are not to be construed as limiting the disclosure. Numerous specific details are described to provide a thorough understanding of various aspects of the present disclosure.

The present disclosure may be embodied in other specific forms without departing from its spirit or essential characteristics. The described aspects are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method comprising:
capturing, by at least one hardware processor, network traffic data of request payloads or response payloads of application programming interface (API) calls in one or more network interactions between a computing system and an additional computing system;
generating, by the at least one hardware processor utilizing a classification neural network, classifications of content of the network traffic data for the computing system according to data types in the request payloads or the response payloads of the API calls; and
generating, for display via a graphical user interface of a client device associated with the computing system, a classification analysis comprising the classifications of the content of the network traffic data and one or more indications of risk levels of the data types in the network traffic data.

2. The method of claim 1, wherein generating the classifications of the content of the network traffic data further comprises:
generating one or more classifications indicating first data without restrictions or second data associated with a set of restrictions; and
generating the one or more indications of risk levels comprising a first risk level for the first data or a second risk level for the second data, the second risk level indicating a higher risk level than the first risk level.

3. The method of claim 1, further comprising:
determining that a risk level associated with a data type identified in the content of the network traffic data exceeds a risk threshold; and
generating, for display at the client device, a notification comprising the risk level and a description of the content of the network traffic data.

4. The method of claim 1, further comprising:
determining, in response to a request comprising a log file by the client device, a sequence of network interactions comprising one or more computing operations that result in the request payloads or the response payloads comprising the network traffic data; and
generating the classification analysis comprising the classifications of the content of the network traffic data by extracting the network traffic data from the log file.

5. The method of claim 1, further comprising:
receiving, via the graphical user interface of the client device associated with the computing system, an API endpoint for a network interaction of the one or more network interactions; and
capturing, the network traffic data by:
causing the computing system to execute the network interaction according to the API endpoint; and
monitoring a request payload or a response payload resulting from the network interaction to determine the network traffic data.

6. The method of claim 1, further comprising:
determining a first risk level for content of first network traffic data captured in connection with a first sequence of interactions;
determining a second risk level for content of second network traffic data captured during a second sequence of interactions; and
generating, for display via the graphical user interface of the client device associated with the computing system, the classification analysis comprising a risk delta comprising a difference between the first risk level and the second risk level.

7. The method of claim 1, further comprising:
determining requirement parameters comprising requirements of a data policy for handling specific data types for the one or more network interactions; and
determining the risk levels of the data types in the network traffic data by comparing the content of the network traffic data to the requirement parameters.

8. The method of claim 1, further comprising:
determining, for a provided API endpoint, one or more expected data types for a response payload corresponding to a request payload of an API call;
capturing the network traffic data comprising the response payload in response to sending the request payload of the API call; and
generating, for display via the graphical user interface of the client device, an indication of the one or more expected data types extracted from the response payload.

9. A system comprising:
a computing system hosting a website and executing application programming interface calls (API) calls to one or more additional computing systems; and
a server device comprising at least one hardware processor configured to:
capture network traffic data of request payloads or response payloads of the API calls in connection with the computing system hosting the website;
generate, utilizing a classification neural network, classifications of content of the network traffic data according to data types in the request payloads or the response payloads of the API calls; and
generate, for display via a graphical user interface of a client device associated with the computing system, a classification analysis comprising the classifications of the content of the network traffic data and indications of one or more risk levels of the data types in the network traffic data.

10. The system of claim 9, wherein the at least one hardware processor is configured to:
determine, from a log file comprising recorded computing operations, a sequence of interactions with the website comprising one or more computing operations that result in the request payloads or the response payloads comprising the network traffic data; and
capture the network traffic data from the sequence of interactions recorded in the log file.

11. The system of claim 9, wherein the at least one hardware processor is configured to generate, for display via a graphical user interface of the client device associated with the computing system, a color-coded risk level dashboard comprising the indications of the one or more risk levels displayed in colors based on criteria comprising a probability of a risk occurrence, an impact severity of the risk occurrence, or an urgency of a risk remediation.

12. The system of claim 9, wherein the at least one hardware processor is configured to:
receive, via the graphical user interface of the client device associated with the computing system, an API endpoint for a network interaction corresponding to a targeted path; and
capture the network traffic data in response to the computing system executing the network interaction corresponding to the targeted path.

13. The system of claim 9, wherein the at least one hardware processor is configured to:
determine, for a provided API endpoint, an expected data type for a response payload corresponding to a request payload of an API call;
capture the network traffic data comprising the expected data type within the response payload in response to sending the request payload of the API call; and
generate, for display via the graphical user interface of the client device, a risk level associated with the network traffic data based on capturing the network traffic data comprising the expected data type.

14. The system of claim 10, wherein the at least one hardware processor is configured to:
determine the one or more risk levels of the data types in the network traffic data based on a data policy associated with the classifications of the content of the network traffic data; and
generate, based on the one or more risk levels, a recommendation to perform a remediation action comprising a modification associated with the computing system.

15. A non-transitory computer readable medium comprising instructions that, when executed by at least one hardware processor, cause the at least one hardware processor to:
capture network traffic data of request payloads or response payloads of application programming interface calls in one or more network interactions between a computing system and an additional computing system;
generate, utilizing a classification neural network, classifications of content of the network traffic data for the computing system according to data types in the request payloads or the response payloads of the application programming interface calls;
determine one or more risk levels associated with classifications of the content of the network traffic data based on one or more sets of data requirements corresponding to the computing system; and
cause, for the computing system, an update to a computing operation associated with the application programming interface calls in response to the one or more risk levels exceeding a risk threshold.

16. The non-transitory computer readable medium of claim 15, further comprising instructions that cause the at least one hardware processor to generate the classifications of the content of the network traffic data by generating a classification for first data without restrictions or second data associated with a set of restrictions.

17. The non-transitory computer readable medium of claim 15, further comprising instructions that cause the at least one hardware processor to cause the computing system to update the computing operation by causing the computing system to update a computing operation to encrypt a portion of the content of the network traffic data or disable a cookie associated with the one or more network interactions.

18. The non-transitory computer readable medium of claim 15, further comprising instructions that cause the at least one hardware processor to determine the one or more risk levels associated with the classifications of the content of the network traffic data by comparing the content of the network traffic data to requirements of a data policy.

19. The non-transitory computer readable medium of claim 15, further comprising instructions that cause the at least one hardware processor to:
determine, based on recorded interactions in a log file, a sequence of network interactions comprising the one or more network interactions between the computing system and the additional computing system; and
generate the classifications of the content the network traffic data by extracting the network traffic data from the log file for the sequence of network interactions.

20. The non-transitory computer readable medium of claim 15, further comprising instructions that cause the at least one hardware processor to:
capture additional network traffic data of request payloads or response payloads of application programming interface calls in one or more additional network interactions between a first computing system and a second computing system;
determine one or more additional risk levels for the one or more additional network interactions; and
generate, for display via a graphical user interface of a client device associated with the computing system, a risk delta indicating a difference between the one or more risk levels and the one or more additional risk levels.
